(19) United States
(12) Patent Application Publication
(10) Pub. No.: US 2021/0309018 A1
(43) Pub. Date: Oct. 7, 2021

(54) LIQUID DELIVERY IN AN INKJET TYPE DISPENSER

(71) Applicant: Hewlett-Packard Development Company, L.P., Spring, TX (US)

(72) Inventors: Paul Allan Osborne, Vancouver, WA (US); Christopher John Amold, Vancouver, WA (US)

(73) Assignee: Hewlett-Packard Development Company, L.P., Spring, TX (US)

(21) Appl. No.: 17/265,987

(22) PCT Filed: Nov. 15, 2018
(86) PCT No.: PCT/US2018/061210

§ 371 Date: Feb. 4, 2021

(51) Int. Cl. B41J 2/175; B41J 2/18

(52) U.S. Cl. CPC B41J 2/17596; B41J 2/17566; B41J 2/18; B41J 2/17509

(57) ABSTRACT

In one example, a liquid delivery system for an inkjet type dispenser includes a printhead unit, a reservoir separate from the printhead unit, a first flow path from the reservoir to the printhead unit, an interconnect to connect to a removable liquid container, a second flow path from the interconnect to the reservoir, and a valve movable between a first position in which the first flow path is open and the second flow path is closed and a second position in which the first flow path is closed and the second flow path is open.

### BACKGROUND

Inkjet type dispensing devices dispense liquid onto a substrate with a printhead or an array of printheads. For example, inkjet printers dispense ink onto paper and other print substrates. For another example, some additive manufacturing machines dispense liquid fusing agents onto a powdered build material with an inkjet type dispenser. Additive manufacturing machines that use inkjet type dispensers are commonly referred to as 3D printers.

### DRAWINGS

FIGS. 1 and 2 illustrate one example of a liquid delivery system for an inkjet type dispenser.

FIGS. 3 and 4 illustrate another example of a liquid delivery system for an inkjet type dispenser.

FIGS. 5-8 illustrate one example of a 3 way, 2 position valve that may be used as a flow path control valve in a liquid delivery system such as the example systems shown in FIGS. 1-4. FIGS. 5 and 6 show the exterior of the valve. FIGS. 7 and 8 are sections showing the interior of the valve.

FIG. 9 illustrates an example method for a liquid delivery system such as the example systems shown in FIGS. 1-4.

The same part numbers designate the same or similar parts throughout the figures. The figures are not necessarily to scale.

### DESCRIPTION

In some inkjet printers, the printheads are assembled in a printbar that spans a full width of the print substrate. Ink is pumped to the printbar from a permanent reservoir separate from the printbar to continuously supply the printheads with ink. The pump circulates ink from the reservoir to the printbar and back to the reservoir to remove air from the printbar and to maintain ink pressure to the printheads during printing. When the printheads are idle, the pump may be run to circulate ink to keep ink components mixed and to continue to carry air away from the printbar. A separate reservoir, pump, and flow path may be used for each of the different color inks, and for each of any other printing liquids that may be dispensed by the printheads. This type of ink delivery system is sometimes called a “continuous ink” system.

Each of the reservoirs in a continuous ink system is periodically refilled with ink. A new flow control has been developed to help simplify the layout of a continuous ink delivery system, using a flow path control valve between the reservoir and the printing unit to switch between the normal flow path for printing and a flow path for refilling the reservoir. A new 3 way, 2 position flow path control valve has also been developed for use in the system to switch between flow paths and to make a fluidic connection to the resupply container. In one example, the flow path control valve includes a hollow needle defining a conduit through which ink flows to a single outlet from two inlets. One inlet receives ink from the reservoir for the normal printing flow path. The other inlet receives ink from a resupply container for the refill flow path. A valve actuator slides along the needle to open one inlet and close the other inlet. Pushing a resupply container on to the valve slides the actuator along the needle to close the inlet to the reservoir and simultaneously open the refill inlet to the resupply container. The refill inlet is located near the end of the needle, which extends into the resupply container so that ink in the resupply container may flow into and through the needle to the outlet.

Examples are not limited to ink, printbars or inkjet printing in general. Examples may be implemented with other printhead units, other inkjet type dispensers and for other liquids. The examples described herein illustrate but do not limit the scope of the patent, which is defined in the Claims following this Description.

As used in this document, “a” and “an” means one or more, “and/or” means one or more of the connected things, and a “liquid” means a fluid not composed primarily of a gas or gases.

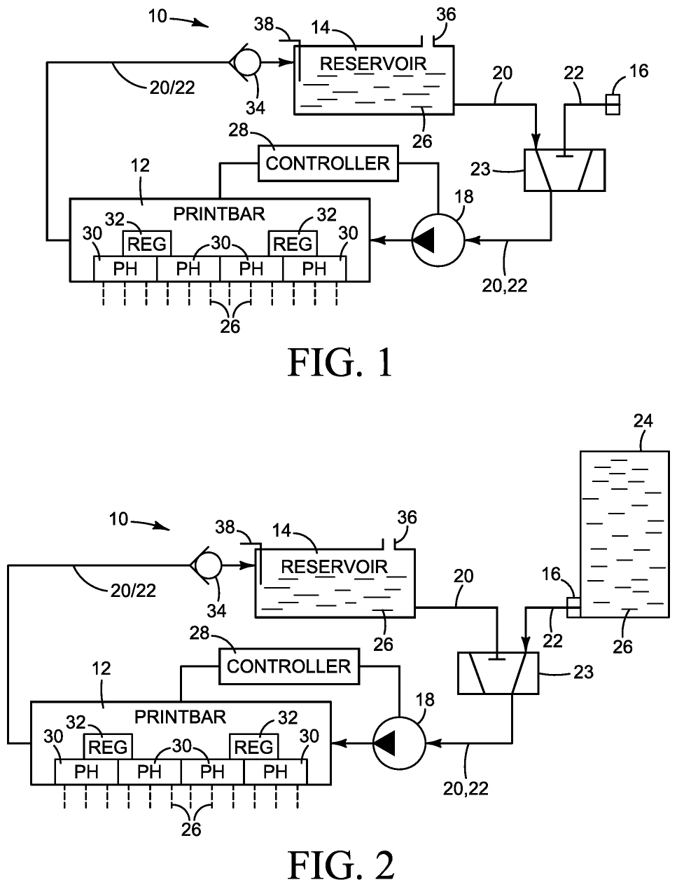

FIGS. 1 and 2 illustrate an example liquid delivery system 10 for an inkjet type dispenser. Referring to FIGS. 1 and 2, system 10 includes a printhead unit 12, a permanent reservoir 14 separate from printhead unit 12, an interconnect 16, a pump 18, a supply flow path 20 from reservoir 14 through printhead unit 12 and back to reservoir 14, and a refill flow path 22 from interconnect 16 to reservoir 14. System 10 also includes a flow path control valve 23 to switch between supply flow path 20 and refill flow path 22. System 10 also sometimes includes a removable liquid container 26, for example during a refill operation. FIG. 1 shows valve 23 switched to supply flow path 20 so that ink or another liquid 26 may flow from reservoir 14 to printhead unit 12 at the urging of pump 18. FIG. 2 shows valve 23 switched to refill flow path 22 so that ink or another liquid 26 may flow from a resupply container 24 to reservoir 14 (through printhead unit 12) at the urging of pump 18.

During printing or another dispensing operation, shown in FIG. 1, valve 23 is switched to supply flow path 20 so that pump 18 may pump liquid 26 from reservoir 14 along supply flow path 20 through printhead unit 12 and back to reservoir 14, for example at the direction of a controller 28. Controller 28 represents the processing and memory resources, programming, and the electronic circuitry and components needed to control the operative components of system 10, and may include distinct control elements for individual system components. When the printhead(s) are idle, pump 18 may be run to continue to circulate liquid through printhead unit 12, for example to keep ink or other components of the liquid mixed and to carry air away from the printhead(s).

During a refill operation, shown in FIG. 2, when a removable container 24 is connected to interconnect 16 and valve 23 is switched to refill flow path 22, pump 18 may pump liquid 26 from container 24 along refill flow path 22 to reservoir 14, for example at the direction of controller 28. In the example shown in FIGS. 1 and 2, refill flow path 22 is coextensive with supply flow path 20 through pump 18 and printhead unit 12 such that liquid continues to circulate through printhead unit 12 during refill. Consequently, the printhead(s) are supplied with liquid while refilling reservoir 14 and dispensing operations may continue, if desired, during refill. A switch or sensor (not shown) may be used to signal controller 28 that a resupply container 24 has been connected to or disconnected from interconnect 16, for example so that controller 28 may direct switching valve 23 to the corresponding flow path and/or to control other components of system 10 fora normal operation or a refill operation.

Printhead unit 12 includes one or multiple printheads to dispense ink or another liquid and flow structures to carry liquid to the printhead(s). A printhead unit 12 usually will also include a pressure regulator or other flow control device to help control the flow of liquid to each printhead. In this example, printhead unit 12 is implemented as a substrate wide printbar with multiple printheads 30 and flow regulators 32 each to regulate the flow of liquid to the corresponding printheads 30. Although a single printhead unit 12 is shown, system 10 may include multiple printhead units 12. A printhead unit 12 may be implemented, for example, in an inkjet printer to dispense ink and/or other printing liquids, or as an agent dispenser in an additive manufacturing machine to dispense fusing, detailing, coloring, and/or other liquid manufacturing agents. Although only one system 10 is shown, each of multiple liquid delivery systems 10 may be used to delivery each of multiple corresponding liquids to one or multiple printing units 12.

Also, in this example, a check valve or other suitable pressure control device 34 is positioned in flow path 20/22 between printbar 12 and reservoir 14 to allow pump 18 to help maintain positive gauge pressure at regulators 32. Reservoir 14 may be vented to the atmosphere through a vent 36. A sensor 38 may be used to detect the level of liquid 26 in reservoir 14 to signal controller 28 or an operator to start or stop a refill operation.

Interconnect 16 may be implemented, for example, as a needle/septum seal or other suitable passive flow device, or as a valve or other active flow device. Interconnect 16 may be a discrete part separate from a container 24, valve 23, and flow paths 20, 22, or interconnect 16 may include components that are part of container 24, valve 23, and/or flow paths 20, 22. Valve 23 may be implemented, for example, as a 3 way, 2 position valve. A flow path control valve 23 may be actuated manually, or automatically by a solenoid or other electro-mechanical device operating under the direction of controller 28.

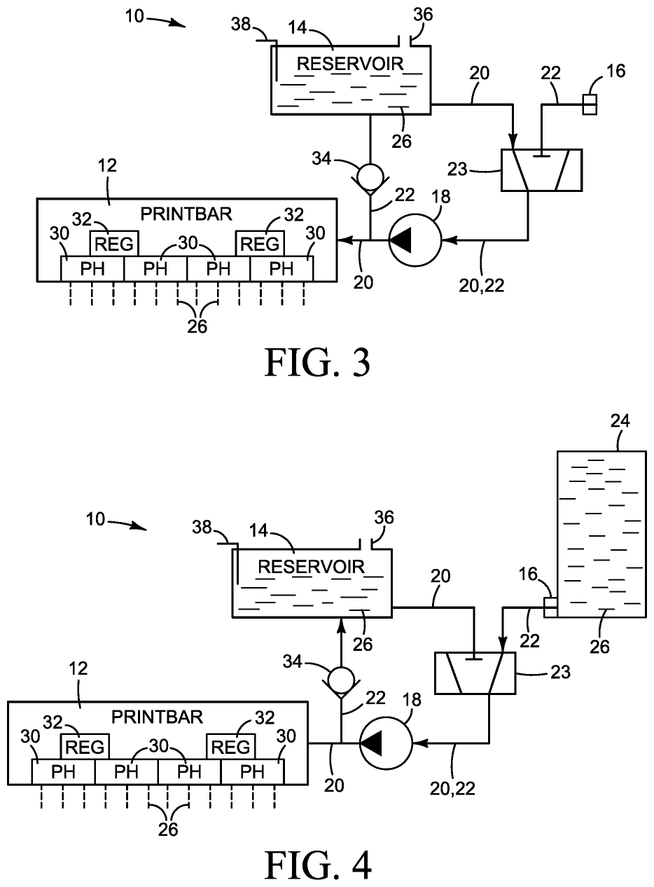

FIGS. 3 and 4 illustrate another example liquid delivery system 10 for an inkjet type dispenser. In this example, supply flow path 20 ends at printbar 12 and refill flow path 22 goes to reservoir 14 without passing through printbar 12. FIG. 3 shows valve 23 switched to supply flow path 20 so that liquid 26 may flow from reservoir 14 to printhead unit 12 at the urging of pump 18. If printbar 12 does not draw liquid from the flow path (through regulators 32), for example when printheads 30 are idle, then liquid 26 may return to reservoir 14 along flow path 22, and thus continue to circulate even when the printheads are idle. FIG. 4 shows valve 23 switched to refill flow path 22 so that liquid 26 may flow from a resupply container 24 to printbar 12 and to reservoir 14 at the urging of pump 18.

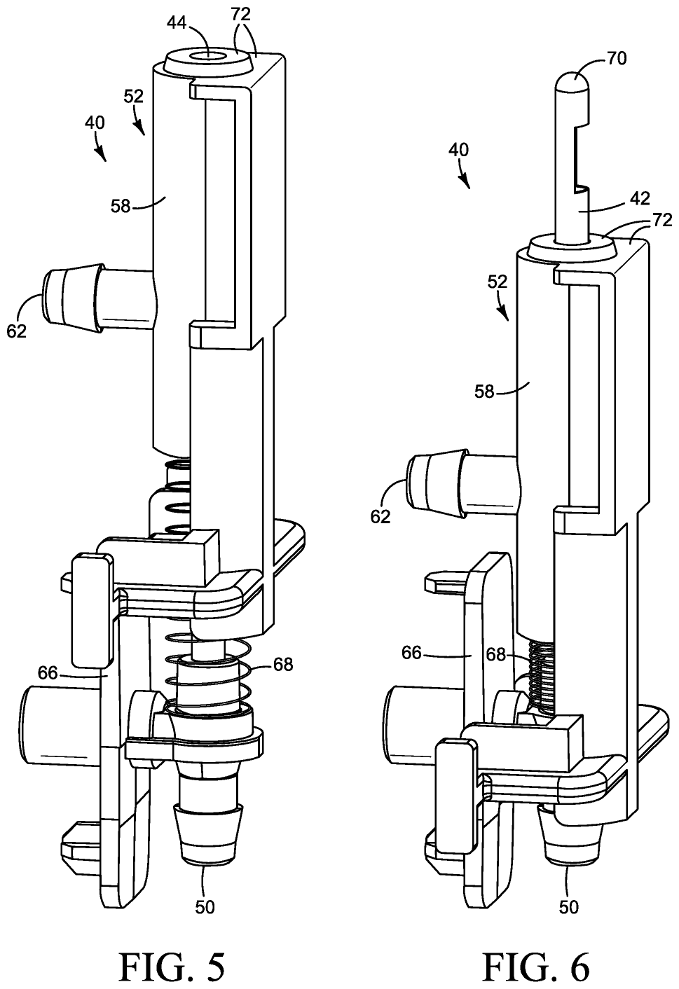

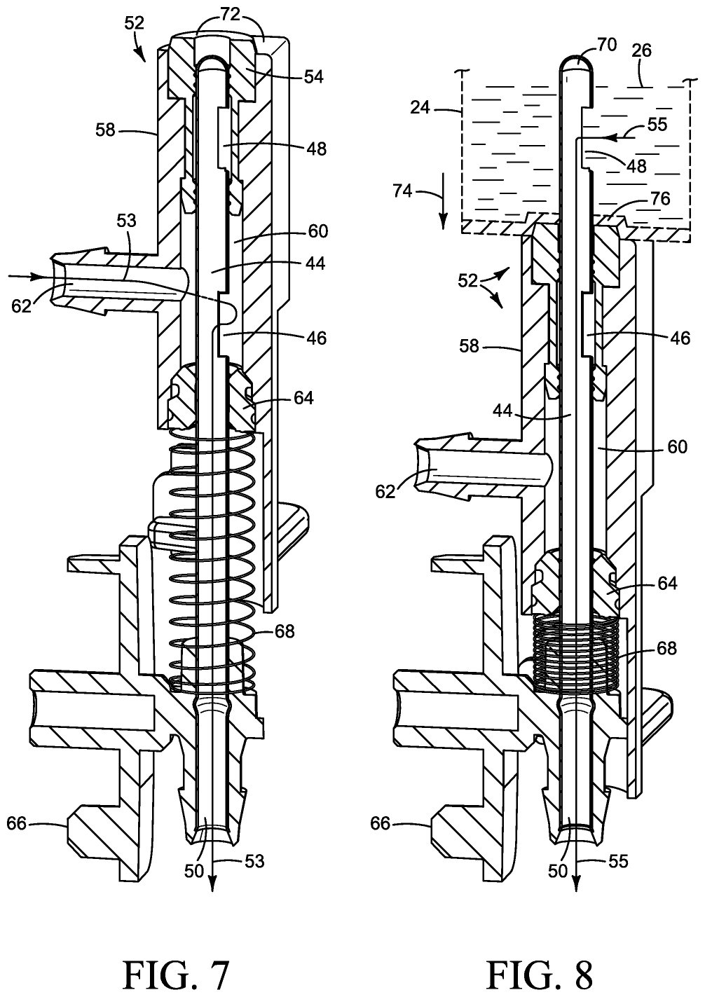

FIGS. 5-8 illustrate one example of a 3 way, 2 position valve 40 that may be used as a flow path control valve 23 in a liquid delivery system 10 shown in FIGS. 1-2 and 3-4. Referring to FIGS. 5-8, valve 40 includes a hollow needle 42 with an internal conduit 44 to carry liquid from a first inlet 46 or a second inlet 48 to a single outlet 50. Valve 40 also includes an actuator 52 that slides back and forth along needle 42 between (1) a first position, shown in FIGS. 5 and 7, in which first inlet 46 is open and second inlet 48 is closed so that fluid may enter conduit 44 through first inlet 46 but not second inlet 48, as indicated by flow arrow 53 in FIG. 7 and (2) a second position, shown in FIGS. 6 and 8, in which first inlet 46 is closed and second inlet 48 is open so that fluid may enter conduit 44 through second inlet 48 but not first inlet 46, as indicated by flow arrow 55 in FIG. 8.

Actuator 52 includes a closure 54 that closes one of the inlets 46, 48 according to the position of the actuator along needle 42. In this example, each inlet 46, 48 is formed by a slot in needle 42. Closure 54, therefore, may be formed as an elongated seal that surrounds needle 42 to cover and thus close and seal the full extent of the slots.

Actuator 52 includes a body 58 that surrounds needle 42. Body 58 moves back and forth along needle 42. Closure 54 is supported in and moves with actuator body 58 to slide back and forth along needle 42 between the actuator first and second positions. An internal chamber 60 surrounding needle 42 adjacent to closure 54. An opening 62 in body 58 to chamber 60 ports fluid to first inlet 46 when inlet 46 is open, as shown in FIG. 7. Chamber 60 is formed in body 58 by closure/seal 54 at one end and a seal 64 at the other end. When actuator 52 is in the first position, shown in FIG. 7, chamber 60 is aligned with first inlet 46 so that fluid in chamber 60 may enter conduit 44 through first inlet 46. When actuator 52 is in the second position, shown in FIG. 8, chamber 60 is not aligned with first inlet 46 so that fluid in chamber 60 cannot enter first inlet 46.

Valve 40 includes a stationary base 66. “Stationary” in this context means that actuator body 58 moves relative to base 66. Valve base 66 may be mounted, for example, to a printer chassis or other fixture supporting components of a liquid delivery system 10 shown in FIGS. 1-2 and 3-4. A spring or other suitable biasing mechanism 68 between actuator body 58 and base 66 continuously urges actuator 52 toward the first position.

The example 3 way, 2 position valve 40 shown in FIGS. 5-8 is designed for use as a flow path control valve 23 in a liquid delivery system 10 shown in FIGS. 1 and 2. In a system 10, reservoir 14 is connected to first inlet 46 and interconnect 16 (and thus a resupply container 24) is connected to second inlet 48. Outlet 50 is connected to common flow path 20, 22.

Valve 40 may itself form part of interconnect 16 connecting a removable container 24 to refill flow path 22. (A removable container 24 is depicted by dashed lines in FIG. 8.) Thus, in this example, second inlet 48 is located near a tip 70 of needle 42. As shown in FIG. 8, when a resupply container 24 is connected (indicated by direction arrow 74), it engages the end 72 of actuator 52 to move the actuator from the first position shown in FIGS. 3 and 5 to the second position shown in FIGS. 6 and 8, and the now exposed tip 70 of needle 42 enters resupply container 24, for example through a septum 76. Thus, connecting a resupply container 24 automatically actuates valve 40 to close first inlet 46 and open second inlet 48 so that liquid 26 may flow from container 24 through conduit 44 to outlet 50. When the resupply container 24 is disconnected, spring 68 automatically returns valve 40 to the first position shown in FIG. 5, closing second inlet 48 and opening first inlet 46.

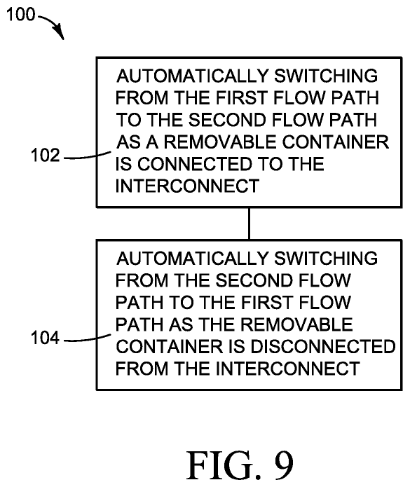

FIG. 9 illustrates an example method 100 such as might be implemented in a liquid delivery system 10 in FIGS. 1-2 and 3-4 using a valve 40 shown in FIGS. 5-8. Part numbers in the description of method 100 refer to FIGS. 1-8. Referring to FIG. 9, method 100 includes automatically switching from a first, supply flow path 20 to a second, refill flow path 22 as a removable container 24 is connected to an interconnect 16 (block 102) and automatically switching from the second flow path 22 to the first flow path 20 as the removable container 24 is disconnected from the interconnect 16 (block 104). Automatically switching from the first flow path to the second flow path at block 102 may include a valve 40 simultaneously closing the first flow path 20 (at first inlet 46) and opening the second flow path 22 (at second inlet 48) as a consequence of connecting a removable container 24 to the valve 40. Automatically switching from the second flow path 22 to the first flow path 20 at block 104 may include the valve 40 simultaneously closing the second flow path 22 (at inlet 48) and opening the first flow path 20 (at inlet 46) as a consequence of disconnecting the removable container 24 from the valve 40.

As noted at the beginning of this Description, the examples shown in the figures and described above illustrate but do not limit the scope of the patent, which is defined in the following Claims.

1. A liquid delivery system for an inkjet type dispenser, comprising:
a printhead unit;
a reservoir separate from the printhead unit;
a first flow path from the reservoir to the printhead unit;
an interconnect to connect to a removable liquid container;
a second flow path from the interconnect to the reservoir; and
a valve movable between a first position in which the first flow path is open and the second flow path is closed and a second position in which the first flow path is closed and the second flow path is open.

2. The system of claim 1, wherein:
the valve is to move from the first position to the second position as a removable liquid container is connected to the interconnect; and
the valve is to move from the second position to the first position as a removable liquid container is disconnected from the interconnect.

3. The system of claim 1, wherein the first flow path is from the reservoir through the printhead unit and back to the reservoir.

4. The system of claim 1, wherein:
the first flow path is from the reservoir through the printhead unit and back to the reservoir; and
the second flow path is from the interconnect through the printhead unit to the reservoir.

5. The system of claim 1, comprising a pump to pump ink along the first flow path when the valve is in the first position and along the second flow path when the valve is in the second position.

6. The system of claim 1, comprising a removable container connected to the interconnect.

7. A liquid delivery system for an inkjet type dispenser, comprising:
a printhead unit;
a reservoir separate from the printhead unit;
a first flow path from the reservoir to the printhead unit;
an interconnect to connect to a removable liquid container;
a second flow path from the interconnect to the reservoir; and
a valve movable between a first position in which the first flow path is open and the second flow path is closed and a second position in which the first flow path is closed and the second flow path is open, the valve comprising:
a hollow needle defining a conduit, the needle having:
a first inlet to the conduit;
a second inlet to the conduit;
a single outlet from the conduit connected to both the first inlet and the second inlet; and
an actuator slidable along the needle between:
a first position in which the first inlet is open and the second inlet is closed so that fluid may enter the conduit through first inlet but not the second inlet; and
a second position in which the first inlet is closed and the second inlet is open so that fluid may enter the conduit through the second inlet but not the first inlet.

8. The system of claim 7, wherein the valve actuator comprises:
a body surrounding part of the needle;
a closure affixed to the body and surrounding the needle;
a chamber inside the body next to the closure and surrounding the needle;
an opening in the body to the chamber; and
the body movable along the needle between:
the actuator first position in which the chamber is aligned with the first inlet and the closure closes the second inlet so that fluid in the chamber may enter the conduit through the first inlet but not the second inlet; and
the actuator second position in which the chamber is not aligned with the first inlet and fluid in the chamber cannot enter the conduit through the first inlet, the closure closes the first inlet, and the second inlet is open.

9. The system of claim 8, wherein the closure is a single closure that alternately closes the second inlet when the actuator is in the first position and closes the first inlet when the actuator is in the second position.

10. The system of claim 9, wherein the second inlet is located near a tip of the needle and the tip of the needle is exposed outside the body when the actuator is in the second position.

11. The system of claim 10, wherein each inlet comprises a slot in the needle.

12. The system of claim 11, wherein the needle is part of the interconnect.

13. A method for a liquid delivery system that includes a printhead unit, a reservoir separate from the printhead unit, a first flow path from the reservoir to the printhead unit, an interconnect to connect to a removable liquid container, and a second flow path from the interconnect to the reservoir, the method comprising:
automatically switching from the first flow path to the second flow path as a removable container is connected to the interconnect; and
automatically switching from the second flow path to the first flow path as the removable container is disconnected from the interconnect.

14. The method of claim 13, wherein:
automatically switching from the first flow path to the second flow path includes a valve simultaneously closing the first flow path and opening the second flow path as a consequence of connecting a removable container to the valve; and
automatically switching from the second flow path to the first flow path includes the valve simultaneously closing the second flow path and opening the first flow path as a consequence of disconnecting the removable container from the valve.
